(19) United States
(12) Patent Application Publication
(10) Pub. No.: US 2016/0087468 A1
(43) Pub. Date: Mar. 24, 2016

(54) Cell phone energy exchange device

(71) Applicant: Bernard Walls, Manassas, VA (US)

(72) Inventor: Bernard Walls, Manassas, VA (US)

(21) Appl. No.: 14/121,550

(22) Filed: Sep. 18, 2014

(51) Int. Cl. H02J 7/00

(52) U.S. Cl. CPC H02J 7/0044

(57) ABSTRACT

The Cell Phone Energy Exchange Device is a small simple device that works between two cell phones exchanging the energy from one battery to another in 5% increments. You can exchange any amount of energy from one cell phone battery to another in a matter of a few minutes.

### BACKGROUND OF THE INVENTION

(1) Field of the Invention

The Cell Phone Energy Exchange Device is in the field of phone charging devices.

(2) Description of the Art Including Information Disclosed Under 37 CFR 1.97 & 1.98

The art described in the drawings of the design and utility function illustrate the unique ability of the Cell Phone Energy Exchange Device and we have found no other patents that are similar enough to cause an issue with the patent application.

### BRIEF SUMMARY OF THE INVENTION

The Cell Phone Energy Exchange Device is a unique device that plugs into any cell phone and draws the energy from the one cell phone battery to another cell phone battery. This helps anyone with a low battery to gain enough power to make an important phone call or other action without depleting the other cell phone battery power by any substantial means.

### BRIEF DESCRIPTION OF THE SEVERAL VIEWS OF THE DRAWINGS

There are 7 drawings in total that describe and illustrate the design and function of the Cell Phone Energy Exchange Device.

FIG. 1: is the ¾ perspective of the device.

FIG. 2: is the front view of the device.

FIG. 3: is the side view of the device.

FIG. 4: is the bottom view of the device.

FIG. 5: is the rear or backside view of the device.

FIG. 6: is the transfer cables and transfer ports of the device.

FIG. 7: is the operational view of the device transferring energy from one cell phone to another.

### DETAILED DESCRIPTION OF THE PREFFERED EMBODIMENT

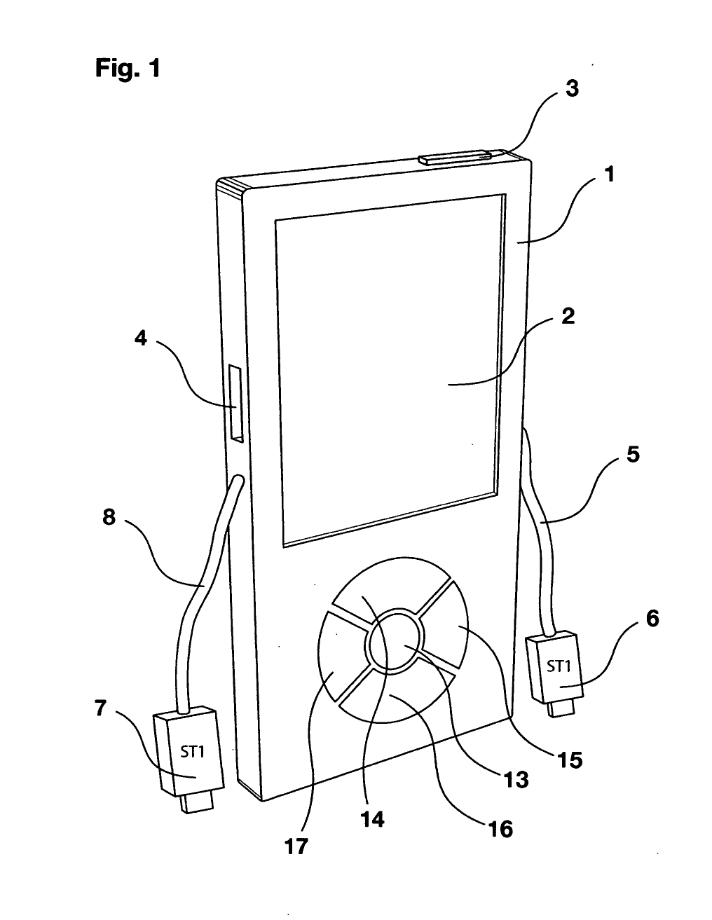

FIG. 1: In this ¾ view illustration #1 is the main body of the device with #2 the LCD screen that shows the transfer of energy from one battery of the first phone to the second phone with the amount of energy transferred and the amount of energy remaining and when the transfer is complete with #3 the on/off button for the device with #4 the port cavity where the transfer port inserts into for a stable storage when not in use with #5 the receiver cable that receives the energy and transfers into the receiving battery with #6 the receiver port that plugs into the second phone to receive the transfer of energy into the battery with #7 the transfer port transferring energy from the first phone battery with #13 the confirmation button which confirms the amount of energy that is to be transferred or exchanged to the other cell phone battery once the percentage is selected with #14 the up arrow that commands the device to exchange the energy to increase in 5% intervals with #15 the right arrow that switches to the second energy receiving cell phone with #16 the down arrow that commands the device to exchange the energy to decrease in 5% intervals with #17 the left arrow that switches to the first energy transferring cell phone.

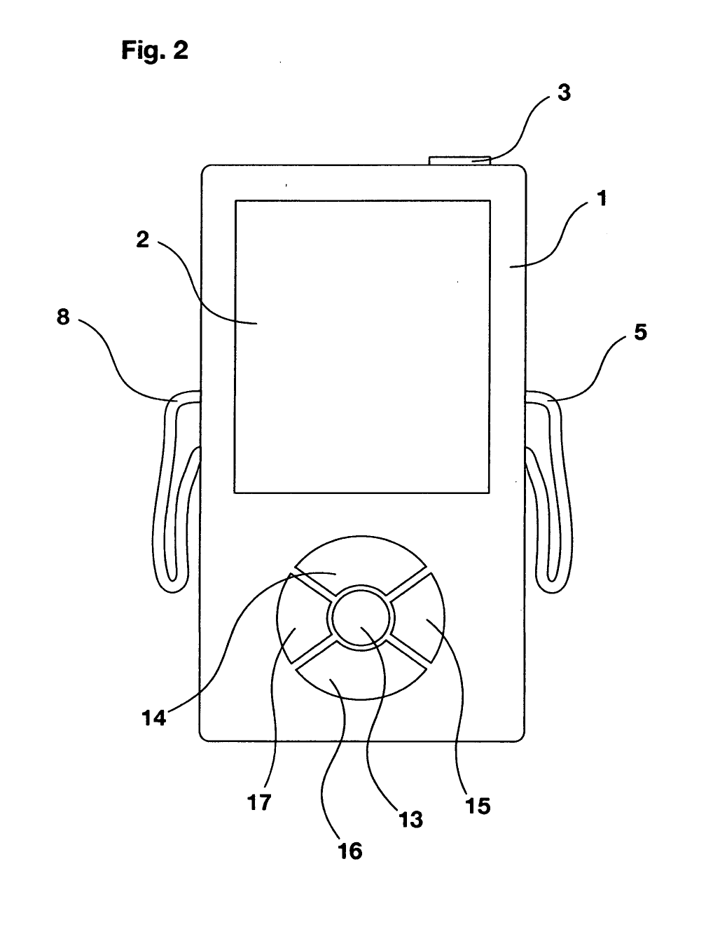

FIG. 2: In this front view illustration #1 is the main body of the device with #2 the LCD screen that shows the transfer of energy from one battery of the first phone to the second phone with the amount of energy transferred and the amount of energy remaining and when the transfer is complete with #3 the on/off button for the device with #5 the receiver cable that receives the energy and transfers into the receiving battery with #8 the transfer cable for the first phone battery that is to be transferred with #13 the confirmation button which confirms the amount of energy that is to be transferred or exchanged to the other cell phone battery once the percentage is selected with #14 the up arrow that commands the device to exchange the energy to increase in 5% intervals with #15 the right arrow that switches to the second energy receiving cell phone with #16 the down arrow that commands the device to exchange the energy to decrease in 5% intervals with #17 the left arrow that switches to the first energy transferring cell phone.

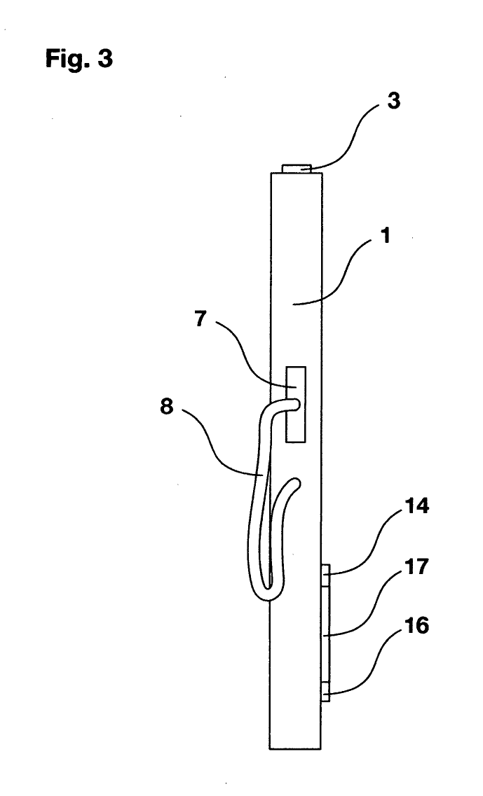

FIG. 3: In this side view illustration #1 is the main body of the device with #3 the on/off button for the device with #7 the transfer port transferring energy from the first phone battery with #8 the transfer cable for the first phone battery that is to be transferred with #14 the up arrow that commands the device to exchange the energy to increase in 5% intervals with #16 the down arrow that commands the device to exchange the energy to decrease in 5% intervals with #17 the left arrow that switches to the first energy transferring cell phone.

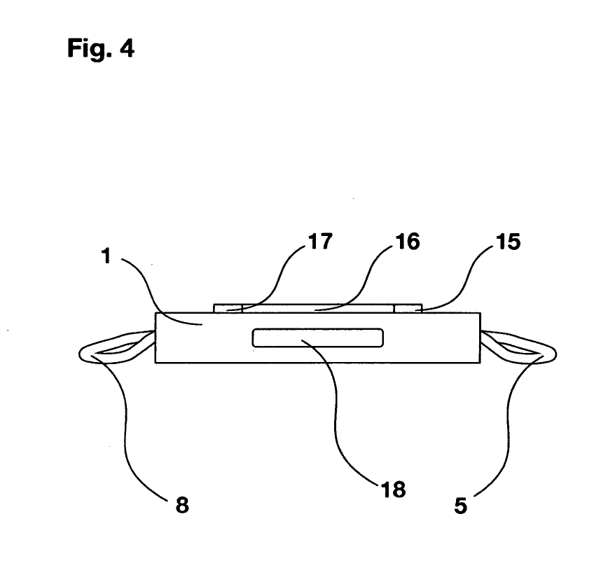

FIG. 4: In this bottom view illustration #1 is the main body of the device #5 the receiver cable that receives the energy and transfers into the receiving battery with #8 the transfer cable for the first phone battery that is to be transferred with #15 the right arrow that switches to the second energy receiving cell phone with #16 the down arrow that commands the device to exchange the energy to decrease in 5% intervals with #17 the left arrow that switches to the first energy transferring cell phone with #18 the device charger port that can plug into a wall socket to charge both phones and the device much faster.

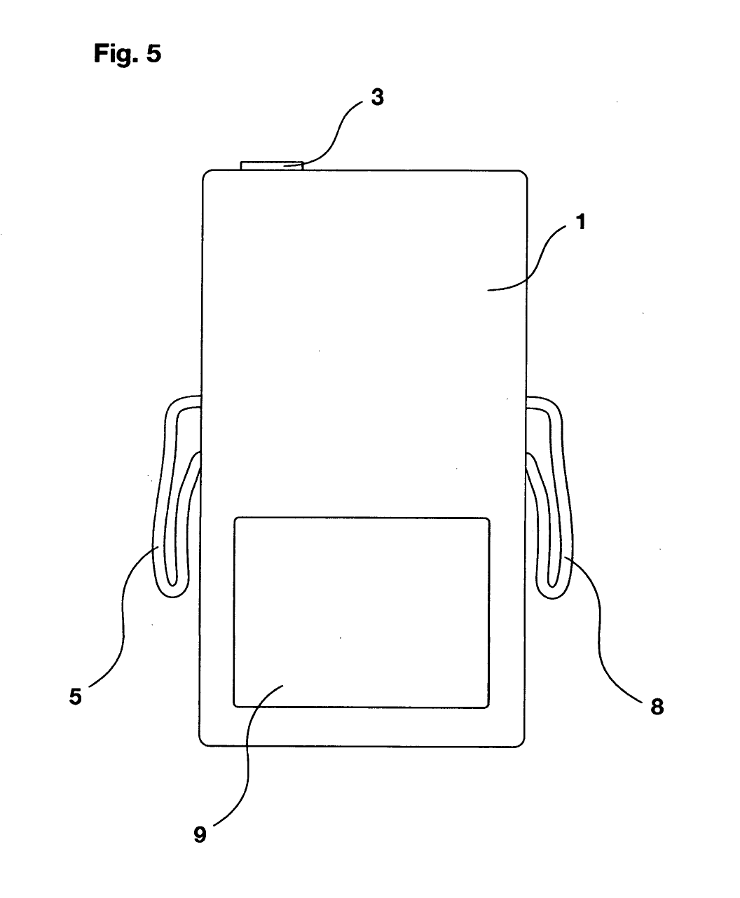

FIG. 5: In this rear or backside view illustration #1 is the main body of the device with #3 the on/off button for the device with #5 the receiver cable that receives the energy and transfers into the receiving battery with #8 the transfer cable for the first phone battery that is to be transferred with #9 the port storage that the energy transferred will be stored and then transferred to the second cell phone battery needing to be charged.

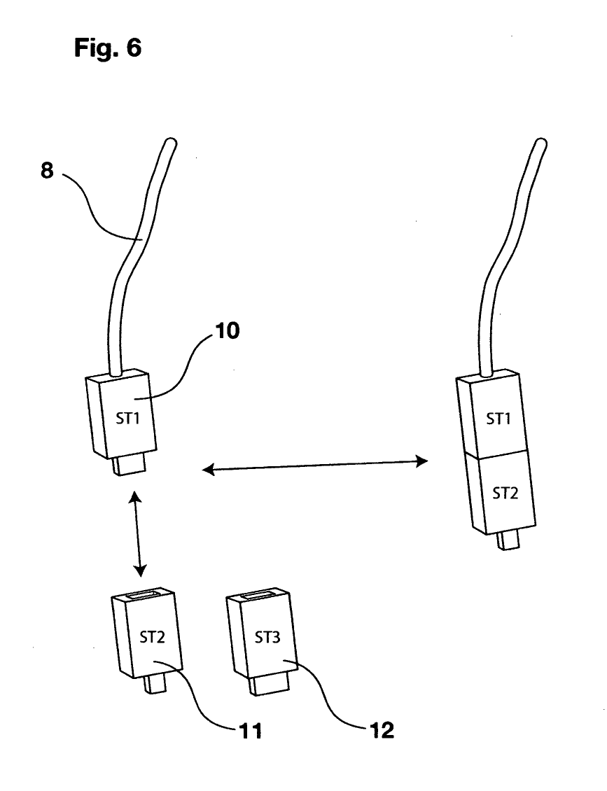

FIG. 6: In this exploded view illustration #8 the transfer cable for the first phone battery that is to be transferred with #10 the standard port design of #7 that fits standard phone ports with #11 the additional port design for certain cell phones and or devices with unique port designs of #7 with #12 the Iphone style devices port design to fit any Iphones style or devices that have that fitting design of #7.

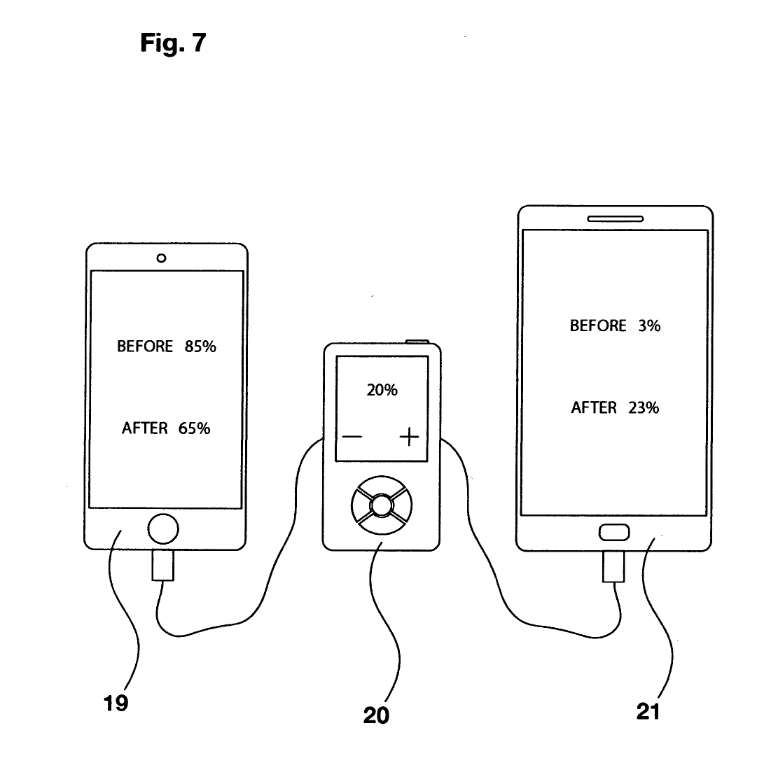

FIG. 7: In this operational front view illustration it shows all three devices with #19 the first phone that is transferring the energy with a before and after percentage of the energy transfer through the #20 energy exchange device set at the percentage of energy to be exchanged with #21 the second phone that is receiving the energy with a before and after percentage of the energy being exchanged.

### DETAILED DESCRIPTION OF THE INVENTION

The Cell Phone Energy Exchange Device has Cell phone ports that come in 3 standard sizes. This device provides the other standard port on other cellphones with 4 of these type of ports are placed in a port storage which is located at the back of the device. As a reminder, these 4 ports are completely different than the ones issued on the retractable cables. ST1 is the standard port for cellphone charging. ST2 is the additional port. ST3 port is for Iphone style devices.

In a typical scenario Device 1 (Droid) has a battery percentage of 85%. This device detects the battery of Device 1 and Device 2. It then transfers 20% of battery life of Device 1 to Device 2 by pressing the confirmation button and you will notice that the after arrow shows the remaining life from both devices. The technology of this device would have to have some updated software to detect the battery of the phone that is being connected. Such a software should have a firmware program that could be updated like any phone software. Once any device is detected the battery shows in the screen for devices and that charge is being complete by running a free flow of current through use of extractable cables consisting on both sides. Extractable cable connectors measure at 9″ in length.

The step by step process of this device is explained as follows:

Step 1

A user using this device will hook up the left cable cord of the device and plug it into Device 1 (Droid). The software would then detect the name of the phone and the amount of battery percentage remaining in that particular device.

Step 2

Then the confirmation button would be pressed to confirm the information of Device 1 (Droid) and begin to Step 3.

Step 3

The user would then hook up the right cable to Device 2.

Step 4

The invention device would then detect Device 2 and display its phone name and battery percentage.

Step 5

Then the confirmation button would be pressed again to confirm the information of Device 2 and begin to Step 6.

Step 6

An interval amount will be displayed on the bottom right corner of the screen by pressing the up or down arrow. Once the amount of percentage is desired by the user (in intervals of 5% the confirmation button would need to be pressed to accept that amount of percentage at say (20%).

Step 7

The exchange of energy of Device 1 (Droid) is now transferred to Device 2. The percentage is revealed to both users cell phones. Device 1 (Droid) had 85% of battery life left and now has 65% of existing battery life on that particular phone. Device 2 had 3% of battery life left and now has increased its percentage to 23% by going through the transfer phase. The Screen will tell the user when the transfer is complete.

The Left and Right Arrows are used to go back and forth between the Two Devices that are being used through this transfer process. The left arrow would show information pertaining to Device 1. The right arrow would show information pertaining to Device 2.

Charging the invention device and other devices:

If both Devices are hooked up to the cables of the invention device while the invention device is being charged from a wall outlet those devices would be charged as well. The flow of electricity that transmits a charge would also transmit a charge to both phone devices by simply being connected to the invention device. A user can use the invention device however they choose, Once a person is done with their transfer process, they can always retransfer battery percentages (in intervals of 5%) by using the device again and hooking it up from left to right. Left being the user whom is transferring battery percentage from Device 1 and Right being the user whom is receiving the transfer of battery to Device 2.

What is claimed is:

1. A Cell Phone Energy Exchange Device with parts comprising of:
a main body of the device the LCD screen that indicates the transfer of energy from one battery of the first phone to the second phone with the amount of energy transferred and the amount of energy remaining and when the transfer is complete;
an on/off button for the device with the port cavity where the transfer port inserts into for a stable storage when not in use;
a receiver cable that receives the energy and transfers into the receiving battery with the receiver port that plugs into the second phone to receive the transfer of energy into the battery with the transfer port transferring energy from the first phone battery with the transfer cable for the first phone battery that is to be transferred;
a port storage that the energy transferred will be stored and then transferred to the second cell phone battery needing to be charged;
a standard port design of that fits standard phone ports with the additional port design for certain cell phones and or devices with unique port designs with the Iphone style devices port design to fit any Iphone style or devices that have that fitting design;

2. A Cell Phone Energy Exchange Device with specific functions comprising of:
a confirmation button which confirms the amount of energy that is to be transferred or exchanged to the other cell phone battery once the percentage is selected;
an up arrow that commands the device to exchange the energy to increase in 5% intervals with the right arrow that switches to the second energy receiving cell phone with the down arrow that commands the device to exchange the energy to decrease in 5% intervals with a left arrow that switches to the first energy transferring cell phone;
a device charger port that can plug into a wall socket to charge both phones and the device much faster with the first phone that is transferring the energy with a before and after percentage of the energy transfer through the energy exchange device set at the percentage of energy to be exchanged with the second phone that is receiving the energy with a before and after percentage of the energy being exchanged.
